(19) United States
(12) Patent Application Publication
(10) Pub. No.: US 2009/0135398 A1
(43) Pub. Date: May 28, 2009

(54) EXPOSURE APPARATUS AND DEVICE MANUFACTURING METHOD

(75) Inventor: Tomoaki Kawakami, Utsunomiya-shi (JP)

Correspondence Address: Locke Lord Bissell & Liddell LLP;Attn: IP Docketing, Three World Financial Center, New York, NY, 10281-2101, US

(73) Assignee: CANON KABUSHIKI KAISHA, Tokyo (JP)

(21) Appl. No.: 12/274,468

(22) Filed: Nov. 20, 2008

(30) Foreign Application Priority Data
Nov. 22, 2007 (JP) 2007-302423

(51) Int. Cl. G03B 27/72; G03B 27/32

(52) U.S. Cl. 355/71; 355/77

(57) ABSTRACT

An exposure apparatus includes an illumination optical system configured to illuminate an original by a luminous flux from a light source and a projection optical system configured to project a pattern of the original onto a substrate. The illumination optical system includes a generator configured to form an effective light source as a light intensity distribution on a surface that has a Fourier transformation relationship with the original and an exposure dose adjuster arranged closer to the light source than the generator and configured to control an exposure dose on an exposure surface. The exposure dose adjuster includes a transmittance adjuster configured to discretely adjust a transmittance of the luminous flux, a zoom optical system configured to adjust a diameter of the luminous flux, and an aperture having a predetermined aperture area that defines a diameter of the luminous flux that has been adjusted by the zoom optical system.

### BACKGROUND OF THE INVENTION

1. Field of the Invention

The present invention relates to an exposure apparatus and a device manufacturing method.

2. Description of the Related Art

A projection exposure apparatus configured to expose a pattern of a reticle or a mask onto a substrate via a projection optical system has conventionally been used, and the high-quality exposure is increasingly demanded which uniformity maintains a critical dimension (“CD”). Maintaining the CD uniformity requires precise control over the exposure dose. However, it is difficult to stabilize an output of an excimer laser that is commonly used for a light source, and thus the exposure-dose control is required at an illumination optical system rather than at the light source.

In this regard, Japanese Patent Laid-Open No. (“JP”) 63-316430 proposes a method of controlling a laser output. JP 61-202437 proposes a method of switching plural light-attenuating filters. On the other hand, the increased number of filters for improved control precision would increase the cost. JP 2006-74035 proposes a method of inclining an optical element in an optical path and of controlling the exposure dose through a reflection of its surface.

Other prior art include JP 10-050599.

However, a control range narrows for a stable laser output of the exposure apparatus, which has recently increasingly been required a narrow band, and thus mere control over a laser output like JP 63-316430 cannot control all exposure doses. The method of JP 61-202437 controls the exposure dose discretely rather than continuously, and thus its control precision of the exposure dose is poor. The method of JP 2006-74035 has a problem in that it is difficult to stably control the exposure dose because the exposure dose varies greatly relative to the inclination angle of the optical element.

Thus, the prior art cannot precisely control the exposure dose. Hence, precise control over the exposure dose is necessary, for example, continuous, wide-range, stable, and fast (or high-throughput) control over the exposure dose is necessary.

### SUMMARY OF THE INVENTION

The present invention is directed to an exposure apparatus that can precisely control the exposure dose.

An exposure apparatus according to one aspect of the present invention includes an illumination optical system configured to illuminate an original by a luminous flux from a light source and a projection optical system configured to project a pattern of the original onto a substrate. The illumination optical system includes a generator configured to form an effective light source as a light intensity distribution on a surface that has a Fourier transformation relationship with the original and an exposure dose adjuster arranged closer to the light source than the generator and configured to control an exposure dose on an exposure surface. The exposure dose adjuster includes a transmittance adjuster configured to discretely adjust a transmittance of the luminous flux, a zoom optical system configured to adjust a diameter of the luminous flux, and an aperture having a predetermined aperture area that defines a diameter of the luminous flux that has been adjusted by the zoom optical system.

Further features of the present invention will become apparent from the following description of exemplary embodiments with reference to the attached drawings.

### BRIEF DESCRIPTION OF THE DRAWINGS

FIG. 1 is a schematic view of an exposure apparatus according to the present invention.

FIG. 2 is a view showing an angular distribution adjustment optical system.

FIG. 3A shows a conical prism as one example of an effective light source generator, and FIG. 3B shows an annular illumination having a small annular ratio.

FIG. 4A shows a conical prism as one example of an effective light source generator, and FIG. 4B shows an annular illumination having a large annular ratio.

FIGS. 5A-5C show an embodiment according to the present invention.

FIG. 6 is a flow chart showing an exposure dose control method.

### DESCRIPTION OF THE EMBODIMENTS

Referring now to the accompanying drawings, a description will be given of an embodiment of the present invention.

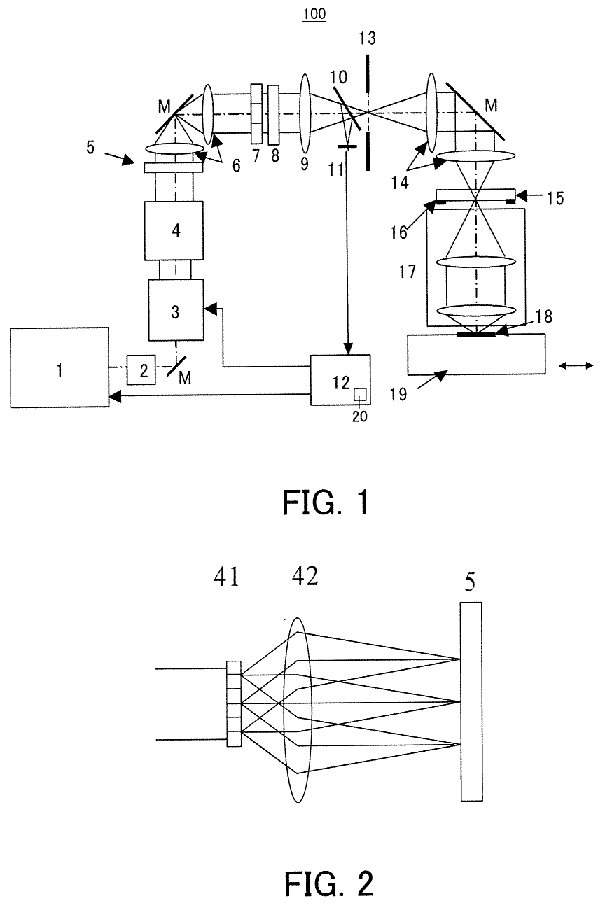

FIG. 1 is a schematic view of structures of an illumination optical system according to the present invention, and an exposure apparatus having the illumination optical system.

A light source 1 of this embodiment is an ArF excimer laser having a wavelength of about 193 nm. However, the present invention may use a KrF laser having a wavelength of about 248 nm for the light source 1, and does not limit a type and a wavelength of the light source and the number of light sources. Therefore, the light source 1 is not limited to a laser, and may be a non-laser, such as a mercury lamp.

A beam deflection optical system 2 condenses a luminous flux from a light source 1, expands and reduces the beam, and introduces the luminous flux to the exposure dose controller 3.

The exposure dose controller 3 serves to control a light amount of the emitted luminous flux, as will be described in detail later.

An angular distribution adjustment optical system 4 includes plural optical elements. The angular distribution adjustment optical system 4 has an effect of maintaining a light intensity distribution on an incident surface of an effective light source generator 5 even when the luminous flux from the light source decenters relative to an optical axis of the illumination optical system or the size of the incident luminous flux varies due to vibrations of a floor and an exposure apparatus. For example, as shown in FIG. 2, a lens array (optical integrator) 41 emits a luminous flux at a constant angle, and uniformly illuminates the incident surface of the effective light source generator 5 through a condenser lens 42.

The effective light source generator 5 includes an element configured to convert a luminous flux into an annular shape or a quadrupole shape according to an illumination condition, such as a circular illumination, an annular illumination, and a quadrupole illumination. A variable power relay lens 6 expands and reduces the luminous flux converted by the effective light source generator 5, and projects it onto the subsequent optical integrator 7. The effective light source is a light intensity distribution on a surface having a Fourier transformation relationship to a pupil plane in an illumination optical system or an illuminated surface (original), and represents an angular distribution of the light incident upon the illuminated surface.

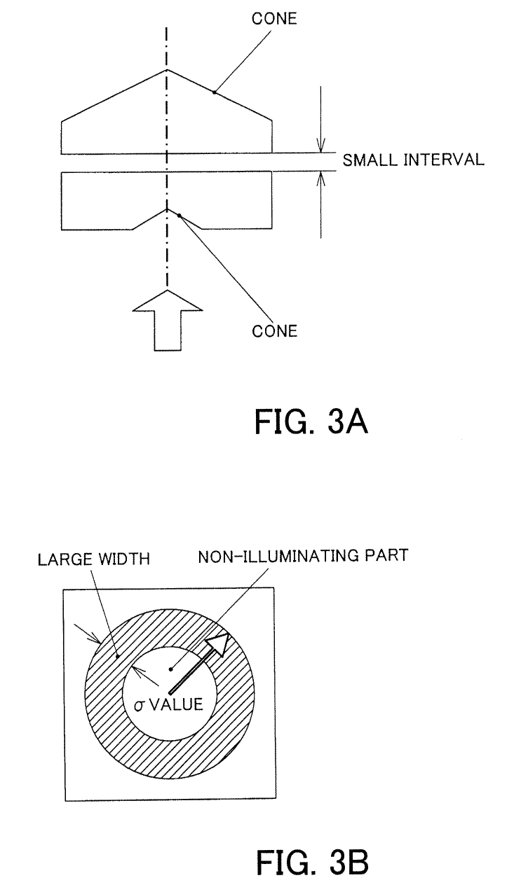

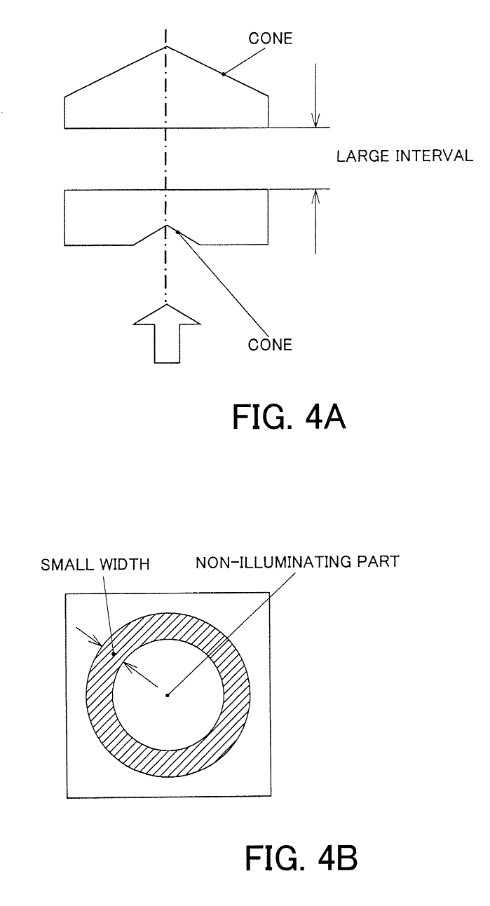

In order to form the conventionally well-known annular effective light source (shown FIG. 3B), the effective light source generator 5 may include a pair of prisms as shown in FIG. 3A. Various effective light sources are available when the pair of prisms is configured movable relative to each other in the optical-axis direction. Assume that one of the pair of prisms has a concave conical incident surface and a flat exit surface, and the other of the pair of prisms has a flat incident surface and a convex conical exit surface. When an interval between them is small as shown in FIG. 3A, an annular effective light source can be formed with a wide light emitting part (or with a small annular ratio) as shown in FIG. 3B. On the other hand, when an interval between them is large as shown in FIG. 4A, an annular effective light source can be formed with a narrower light emitting part (or with a large annular ratio) as shown in FIG. 4B. The annular ratio is defined as a value of an internal diameter (internal o) divided by an outer diameter (external o) of a light intensity distribution. This configuration improves a generation freedom of the effective light source according to a pattern to be generated. Moreover, when it is combined with the subsequent variable power relay lens 6, the size of the effective light source (σvalue) becomes adjustable while the annular ratio is maintained. A light shielding member 8 is located near the exit surface of the optical integrator 7. A surface of the light shielding member 8 has a conjugate relationship with a pupil plane of a projection optical system 17. A shape of the light shielding member 8 can provide various modified illuminations.

The optical integrator 7 is, for example, a micro lens array that has plural two-dimensionally arranged dioptric or catoptric optical elements, or a diffraction optical element, such as a Fresnel lens. A condenser optical system 9 condenses the luminous flux emitted from the optical integrator 7, and illuminates a surface of a movable field stop 13 in a superposition manner.

A half mirror 10 splits the light to an exposure dose sensor 11 as a measurement unit, and an output signal of the exposure dose sensor 11 is input to a controller 12, which, in turn, controls the exposure dose on a substrate (illuminated surface). The exposure dose control is achieved as a result of that the controller 12 controls the light source 1 and the exposure dose controller 3. The controller 12 has a memory 20. The exposure dose sensor is not limited to an illustrated position, and may be located at a position of the original or substrate plane so as to directly measure the exposure dose.

The movable field stop 13 is located conjugate with the illuminated surface in which the original 15 is located. The movable field stop 13 has plural movable light-shielding plates, and limits an illumination range of the illuminated surface when the movable field stop 13 is controlled to form an arbitrary opening shape.

The luminous flux that has passed the movable field stop 13 is introduced to the illuminated surface via the condenser optical system 14 and the mirror M.

The original (mask or reticle) 15 is held on an original stage 16.

The pattern of the original 15 in the illuminated surface is transferred to the substrate (wafer or glass plate) 18 located at an exposure surface by a projection optical system 17.

A substrate stage 19 holds the substrate 18, and is controlled to move in the optical-axis direction and to two-dimensionally move along the plane orthogonal to the optical axis.

A scanning exposure method provides scanning exposure by synchronizing the original 15 and the substrate 18 in an arrow direction of FIG. 1. When a reduction ratio of the projection optical system is 1/β and a scan speed of the substrate stage 19 is V, the scan speed of the original stage 16 is βV.

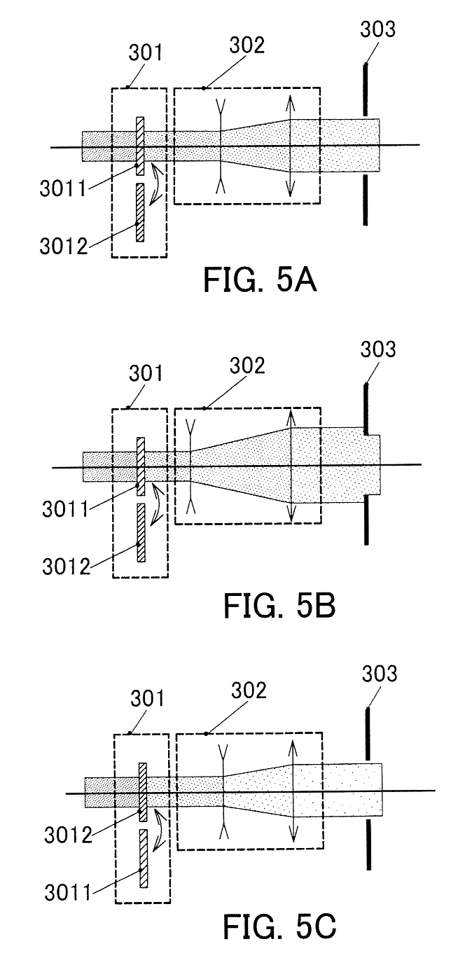

Referring to FIG. 5, a description will be given of a first embodiment according to the present invention, more specifically, the exposure dose controller 3 configured to control the exposure dose of the substrate (exposure surface).

301 denotes a transmittance adjuster that includes plural light-attenuating filters (ND filters) each of which has a different transmittance and is configured to attenuate the exit light amount, and a turret (selector) configured to select one of the light-attenuating filters. 302 is a luminous flux (beam) diameter adjustment optical system (zoom optical system) configured to adjust a luminous flux (beam) diameter on a beam diameter on an exit surface through zooming. 303 is an aperture(a luminous flux diameter setting part) having a predetermined aperture area (ex. constant area) to limit a diameter of the outgoing luminous flux.

FIGS. 5A-C show an embodiment of optical exposure-dose control. The exposure condition is common to FIGS. 5A-C other than the exposure dose controller 3. FIG. 5A uses a light-attenuating filter 3011 for exposure. FIG. 5C uses a light-attenuating filter 3012 for exposure. The light-attenuating filter 3012 is the lower filter than the light-attenuating filter 3011 among the plural light-attenuating filters. For the continuous expose-dose control, the beam diameter adjustment optical system 302 expands the luminous flux beyond the effective area (aperture area) as shown in FIG. 5B, and adjusts the light amount incident upon the effective area. Although FIGS. 5A-5C show the beam diameter adjustment optical system including two lenses for simplicity, the number of lenses is not limited to two and it may include a dioptric or catoptric optical system configured to adjust the beam diameter. In order to maintain a characteristic of an effective light source or the like, the size of the beam of the optical system subsequent to the aperture 303 can be maintained constant.

When the beam diameter adjustment optical system 302 has a minimum magnification, the beam diameter on the surface of the aperture 303 is as large as the effective area. When the beam diameter adjustment optical system 302 adjusts a beam diameter of the exit luminous flux, a great change of the intensity distribution is prevented on the exit surface of the aperture 303. This configuration can prevent a great fluctuation of the beam diameter, and a change of the optical characteristic on the subsequent optical system. Moreover, there can be provided at least two angular distribution adjustment optical elements (exit angle adjustment elements) including the optical integrator shown in FIG. 2 subsequent to the aperture 303. In addition, the aperture 303 can be arranged prior to the effective light source generator 5. This configuration can mitigate the influence of the light distribution change on the surface of the aperture 303 and surely restrain fluctuations to the subsequent optical characteristic. Approximately uniform light-amount attenuations on the luminous-flux section can provide a stable optical characteristic.

In order to further attenuate the light amount provided by the light-attenuating filter 3011 when the beam diameter adjustment optical system 302 has the maximum magnification, the light-attenuating filter 3011 is changed to the light-attenuating filter 3012 as shown in FIG. 5C. The light attenuation amount that is achievable when the light-attenuating filter 3012 is used with the beam diameter adjustment optical system 302 having the minimum magnification can be set as high as the light attenuation amount that is achievable when the light-attenuating filter 3011 is used with the beam diameter adjustment optical system 302 having the maximum magnification. For latitude, the latter can be slightly lower than the former. More specifically, the beam diameter on the exit surface of the aperture 303 that is used when the beam diameter adjustment optical system 302 has the minimum magnification may occupy ninety percent or more of the effective area.

Between two light-attenuating filters having close transmittances, the transmittance of the light-attenuating filter having a low transmittance divided by the transmittance of the light-attenuating filter having a high transmittance will be referred to as a light-attenuation step. Assume that the beam diameter adjustment optical system can change the light amount incident upon the aperture by 100% to T %. In continuously controlling the light amount, the light attenuation step needs to be T % or greater. When the light amount is controlled from 100% to 1% and t=0.01×T, the number of necessary light-attenuating filters is −(2/log t) or more in view of tⁿ<0.01. When T % is 50%, the number of necessary light-attenuating filters is 7 by substituting t=0.5 for the above equation without using many light-attenuating filters. When the beam diameter adjustment optical system 302 has a larger enlargement ratio, more light-attenuating filters can be saved. When there are plural sets of light-attenuating filters, the light-attenuating filter can be saved. Although it is difficult for a normal light attenuator to secure a large variable range for continuous light attenuations, the present invention can adjust the light amount in such a wide range as between 0.01% and 100% with a simple structure.

While the first embodiment of the present invention discusses the exposure dose controller 3 that controls the exposure dose for the exposure process, the present invention is not limited to this embodiment. Another embodiment of the present invention includes an exposure dose controller 3 configured to control the light amount for the measurement system in the exposure apparatus. The exposure dose controller 3 used for the measurement system of the exposure apparatus and that used for the exposure process have the same structure, and a detailed description thereof will be omitted. A very small light amount used for the measurement system in the exposure apparatus is 0.01% or below. The present invention can control the light amount used for the measurement system in the exposure apparatus in a range between 0.01% and 30%, for example, and adjust the exposure dose used for the exposure process in a range between 30% and 100%.

This method can facilitate continuous exposure dose control. For example, the exposure dose that is achievable with the light-attenuating filter and the zoom position of the beam diameter adjustment optical system is measured prior to exposure, and stored in the memory 20. By so doing, a necessary exposure dose can be immediately set in the exposure apparatus.

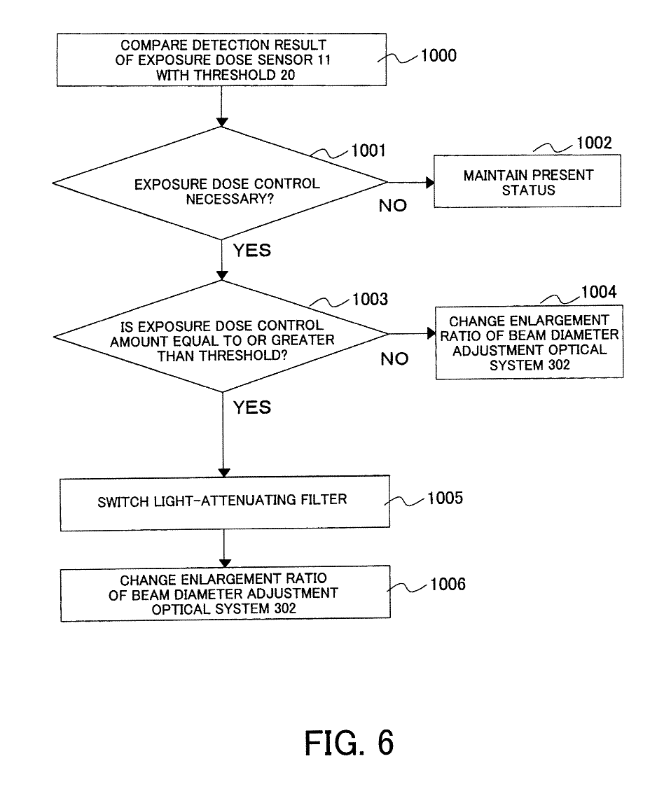

Referring now to FIG. 6, a description will be given of an exposure-dose control method according to one embodiment of the present invention. FIG. 6 is a flowchart of the exposure-dose control method executed by the controller 12.

The controller 12 compares a detection result of the exposure dose sensor 11 with a threshold (data) in the memory 20 (step 1000), and determines whether the exposure dose control is necessary (step 1001). When determining that the exposure dose control is necessary, the controller 12 then determines whether a control amount of the exposure dose is equal to or higher than the threshold (step 1003). When determining that the exposure dose control is unnecessary, the controller 12 maintains the present state (step 1002).

When determining that the exposure-dose control amount is equal to or higher than the threshold (step 1003) the controller 12 selects one of the plural light-attenuating filters 301 which has an exposure dose closest to a target value (step 1005). Thereafter, the beam diameter adjustment optical system 302 controls the exposure dose to the target value (step 1006). When the exposure-dose control amount is smaller than the threshold, the beam diameter adjustment optical system 302 controls the exposure dose to the target value (step 1004).

The present invention thus promptly controls the exposure dose to the target exposure dose, and provides an exposure apparatus having a high speed or high throughput.

For continuous exposure dose control, the exposure dose controller 3 according to the present invention may be configured to have the extremely small number of light-attenuating filters 301 and a wide expansion/reduction range of the beam diameter adjustment optical system 302, for example. However, this configuration enlarges the beam diameter adjustment optical system 302 in the exposure apparatus 100, and finally enlarges the entire size of the exposure apparatus. In addition, a wide expansion/reduction range causes a longer expansion/reduction time period, lowering the throughput. On the contrary, the large number of light-attenuating filters 301 and a narrow expansion/reduction range of the beam diameter adjustment optical system 302 would make the entire exposure apparatus expensive.

Therefore, the present invention sets the number of light-attenuation filters 301 to 2 to 5 used for the exposure process, and the light-amount attenuation amount of the beam diameter adjustment optical system 302 to 0 to 30%. Less than two light-attenuation filters 301 would cause a wide expansion/reduction range of the beam diameter adjustment optical system 302, enlarging the exposure apparatus 100 and lowering the throughput. More than five light-attenuating filters 301 would increase the cost of the exposure apparatus. Similarly, a light attenuation amount by the beam diameter adjustment optical system 302 greater than 30% would cause a large exposure apparatus and a low throughput.

The present invention restricts the number of light-attenuating filters 301, and the attenuation amount of the beam diameter adjustment optical system 302, continuously and precisely controls the exposure dose, and provides an inexpensive and small exposure apparatus.

Thus, use of the light-attenuating filters 301 and the beam diameter adjustment optical system 302 can simply and less expensively control the exposure dose. In exposure dose control, the luminance of the luminous-flux section is always uniformly reduced and the aperture 303 uniformly maintains the size of the luminous-flux section. Thereby, stable exposure dose control can be provided in the performance.

This embodiment manufactures devices via the development step of the substrate after the thus-structured exposure apparatus 100 exposes the substrate.

A device, such as a semiconductor integrated circuit device and a liquid crystal display device, is manufactured by the step of exposing a photosensitive agent applied substrate (a wafer and a glass plate) using the above exposure apparatus, the step of developing the substrate, and other well-known steps.

Use of the manufacturing method of this embodiment can precisely manufacture semiconductor devices faster than ever. Thus, the device manufacturing method that uses the exposure apparatus 100, and resultant devices also constitute one aspect of the present invention.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2007-302423, filed on Nov. 22, 2007, which is hereby incorporated by reference herein its entirety.

What is claimed is:

1. An exposure apparatus comprising:
an illumination optical system configured to illuminate an original by a luminous flux from a light source; and
a projection optical system configured to project a pattern of the original onto a substrate,
wherein the illumination optical system includes:
a generator configured to form an effective light source as a light intensity distribution on a surface that has a Fourier transformation relationship with the original; and
an exposure dose adjuster that is arranged closer to the light source than the generator and configured to control an exposure dose on an exposure surface,
wherein the exposure dose adjuster includes:
a transmittance adjuster configured to discretely adjust a transmittance of the luminous flux;
a zoom optical system configured to adjust a diameter of the luminous flux; and
an aperture having a predetermined aperture area that defines a diameter of the luminous flux that has been adjusted by the zoom optical system.

2. An exposure apparatus according to claim 1, wherein the illumination optical system further includes plural optical integrators that are arranged subsequent to the exposure dose adjustor.

3. An exposure apparatus according to claim 1, wherein the transmittance adjuster includes:
plural light-attenuating filters; and
a selector configured to select one of the plural light-attenuating filters and to insert the selected one in light path.

4. An exposure apparatus according to claim 1, further comprising:
a measurement unit configured to measure a light amount; and
a controller configured to control the exposure dose adjuster based on a measurement result of the measurement unit.

5. A device manufacturing method comprising steps of:
exposing a substrate by using an exposure apparatus; and
developing the substrate that has been exposed,
wherein the exposure apparatus includes:
an illumination optical system configured to illuminate an original by a luminous flux from a light source; and
a projection optical system configured to project a pattern of the original onto a substrate,
wherein the illumination optical system includes:
a generator configured to form an effective light source as a light intensity distribution that is a light intensity distribution on a surface that has a Fourier transformation relationship with the original; and
an exposure dose adjustor that is arranged closer to the light source than the generator and configured to control an exposure dose on an exposure surface,
wherein the exposure dose adjustor includes:
a transmittance adjuster configured to discretely adjust a transmittance of the luminous flux;
a zoom optical system configured to adjust a diameter of the luminous flux; and
an aperture having a predetermined aperture area that defines a diameter of the luminous flux that has been adjusted by the zoom optical system.
